(19) United States
(12) Patent Application Publication
(10) Pub. No.: US 2006/0117527 A1
(43) Pub. Date: Jun. 8, 2006

(54) Hinge mechanism for a foldable electronic device

(75) Inventors: Ying-Liang Tu, Shenzhen (CN); Chao Duan, Shenzhen (CN); Mao-Fa Jiang, Shenzhen (CN); Qin Ou-Yang, Shenzhen (CN); Zheng-Fang Wen, Shenzhen (CN); Chia-Hua Chen, Tu-cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO., LTD, Shindian City (TW)

(21) Appl. No.: 11/228,941

(22) Filed: Sep. 16, 2005

(30) Foreign Application Priority Data
Dec. 3, 2004 (CN) 200420102391.X

(51) Int. Cl. E05F 1/08

(52) U.S. Cl. 16/303

(57) ABSTRACT

A hinge mechanism includes a shaft (1), at least one cam follower (12), a cam (2), a washer (3) and an elastic member (4). Each cam follower has a projection (120) connected to the shaft. The cam has a cam surface (24) defined thereon. The shaft runs through the cam, the washer and the elastic member, in turn. The cam surface of the cam faces the projection of each cam follower, and the cam abuts the cam follower, due to the spring force generated by the elastic member. The washer and the cam are magnetic, the facing portions thereof having the same polarity. As a result of the repulsive magnetic force between the cam and washer, the hinge mechanism generates a smaller friction therebetween, so the waste of energy is very small. The present hinge mechanism can be used in foldable electronic devices.

### BACKGROUND OF THE INVENTION

1. Field of the Invention

The present invention generally relates to hinge mechanisms and, more particularly, to a hinge mechanism for hinging together housings of a foldable, portable electronic device such as a mobile phone or a PDA (Personal Digital Assistant).

2. Discussion of the Related Art

Portable mobile phones generally have two housings rotatably joined by a type of hinge that allows the housings to fold upon one another. Many such foldable mobile phones have most of the electronics in one housing, called the main housing, and fewer electronics in the other housing, called the cover. Other such foldable mobile phones have all the electronics in the main housing, with the cover serving only to cover a keypad and a display of the main housing. The main housing and the cover are connected together by a hinge mechanism. Generally, the opening or closing of most covers is achieved by means of a cam mechanism and a spring of the hinge mechanism.

A typical hinge mechanism for foldable mobile phones comprises a shaft, an elastic member, a cam and a cam follower. The cam and the cam follower each have a cam surface attached to the other. The cam, the cam follower and the elastic member surround the shaft. The elastic member directly stands against the cam. The cam follower matches (i.e., mates and operatively connects) with a main housing of the portable mobile phone. In a similar fashion, the cam matches with a cover. When opening the cover, the cam rotates together with the cover, and it rotates relative to the elastic member and the cam follower. Therefore, a large friction is existing between the cam and the elastic member.

It can be seen that, a lot of energy is wasted, via friction, in the above-described hinge mechanism. In addition, it is difficult to open the cover smoothly because of the substantial degree of friction. Further, the friction will result in abrasion, which will shorten the lifetime of the hinge mechanism and eventually make the hinge mechanism perform in an unstable manner.

What is needed, therefore, is a hinge mechanism which generates a much smaller friction between the cam mechanism and the elastic member.

### SUMMARY OF THE INVENTION

A hinge mechanism includes a shaft, a cam follower, a cam, an elastic member and a washer. The cam follower has a projection connected to the shaft. The cam has a cam surface and a cam hole defined therein. The shaft runs through the cam, the washer and the elastic member, in turn. The cam surface of the cam faces the projection of cam follower, and the cam stands or abuts against the cam follower due to the elastic nature (i.e., spring force) of the elastic member. The washer and the cam are magnetic, and the ends/faces of the washer and the cam having respective facing portions, the respective facing portions having the same polarity.

An electronic device includes a main housing, a cover, and a hinge mechanism configured for rotatably hinging the main housing and the cover. The hinge mechanism includes a shaft, cam follower, a cam, an elastic member and a washer. The cam follower has a projection connected to the shaft. The cam has a cam surface and a cam hole defined therein. The shaft runs through the cam, the washer and the elastic member, in turn. The cam surface of the cam faces the projection of the cam follower, and the cam abuts against the cam follower due to the elastic nature of the elastic member. The washer and the cam are magnetic, and the ends/faces of the washer and the cam having respective facing portions, the respective facing portions having the same polarity.

When opening the cover, the cam rotates relative to the washer. There is a space or clearance that exists between the cam and the washer due to the repulsive nature of having the same polarity face-to-face. Therefore, the matched polarity faces will reduce or eliminate friction and save energy. Thus, the hinge mechanism should serve longer and run more stably over that time span.

Other advantages and novel features of preferred embodiments of the present hinge system and its applications will become more apparent from the following detailed description when taken in conjunction with the accompanying drawings.

### BRIEF DESCRIPTION OF THE DRAWINGS

Many aspects of the present hinge mechanisms and their applications can be better understood with reference to the following drawings. The components in the drawings are not necessarily to scale, the emphasis instead being placed upon clearly illustrating the principles of the hinge mechanisms. Moreover, in the drawings, like reference numerals designate corresponding parts throughout the several views.

FIG. 1 is an exploded, isometric view of a hinge mechanism in accordance with a preferred embodiment of the present hinge system;

FIG. 2 is an assembled, isometric view of the hinge mechanism of FIG. 1;

FIG. 3 is similar to FIG. 2, showing another state of the hinge mechanism; and

FIG. 4 is an isometric view of an electronic device, employing the hinge mechanism of FIGS. 1-3, with the hinge mechanism being shown in phantom.

### DETAILED DESCRIPTION OF PREFERRED EMBODIMENTS

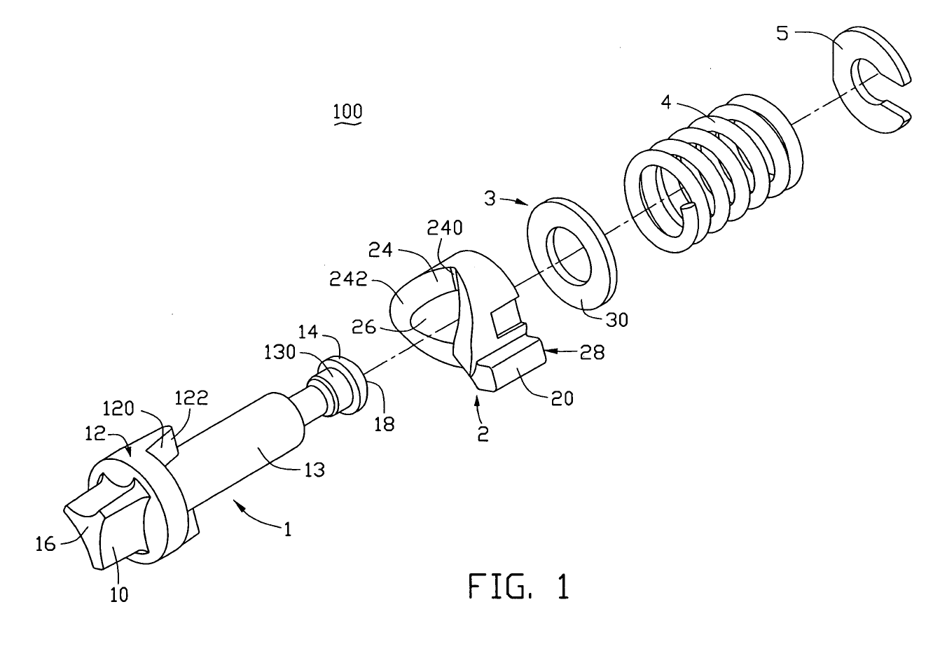

Referring to FIG. 1, a hinge mechanism 100 includes a shaft 1, a cam 2, a washer 3, a spring 4 and a ring 5.

The shaft 1 includes a stop portion 10, a rotating portion 12 (i.e., cam follower), a shaft portion 13 and a flange 14, arranged in turn. The shaft 1 has a first shaft end 16 and an opposite second shaft end 18. The stop portion 10 is formed at the first shaft end 16, and the flange 14 is formed at the second shaft end 18. Two projections or extensions 120, each with a tip 122 on the top (i.e., distal portion) thereof, extend axially and symmetrically from the rotating portion 12. A small shaft 130 is disposed adjacent to the flange 14. A diameter of the small shaft 130 is smaller than that of the shaft portion 13 and the flange 14.

The cam 2 is column-shaped with a through hole 26 running though and along a center axis thereof. A rib 20 is formed on the outside wall of the cam 2. A cam surface 24 is formed on one end of the cam 2. The cam surface 24 includes a pair of valleys 240 and a pair of peaks 242 which are respectively symmetrical. The cam 2 is magnetic. The cam 2 further includes a flat cam face 28 opposite to the cam surface 24, the flat cam face 28 having a first polarity associated therewith.

The washer 3 is ring-shaped and magnetic. A first washer end or face 30 of the washer 3 faces the cam 2. The first washer face 30 has the same polarity (i.e., the first polarity) as the flat cam face 28. This match of polarities produces a repulsive magnetic force between the cam 2 and the washer 3.

The spring 4 is column-shaped and is placed around the shaft 1. The cam surface 24 of the cam 2 always contacts to the projections 120 of the rotating portion 12 due to the elastic nature (i.e., configured for generating a spring force when compressed/extended) of the spring 4. The ring 5 is C-shaped. The ring 5 surrounds the small shaft 130 to stop the spring 4 from falling off the shaft portion 13.

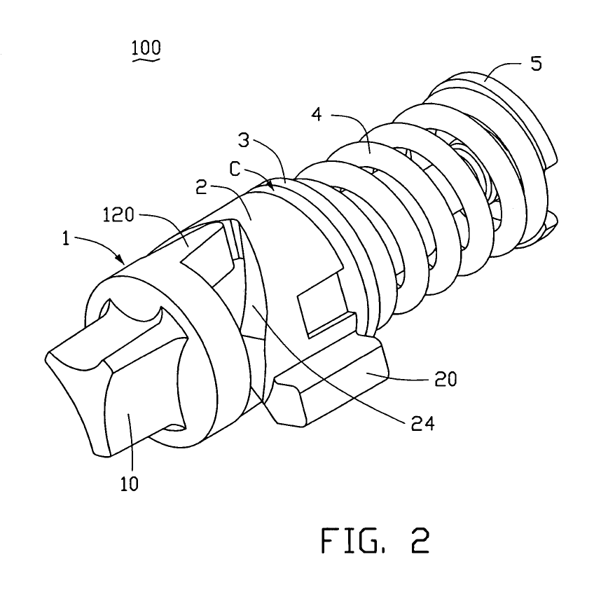

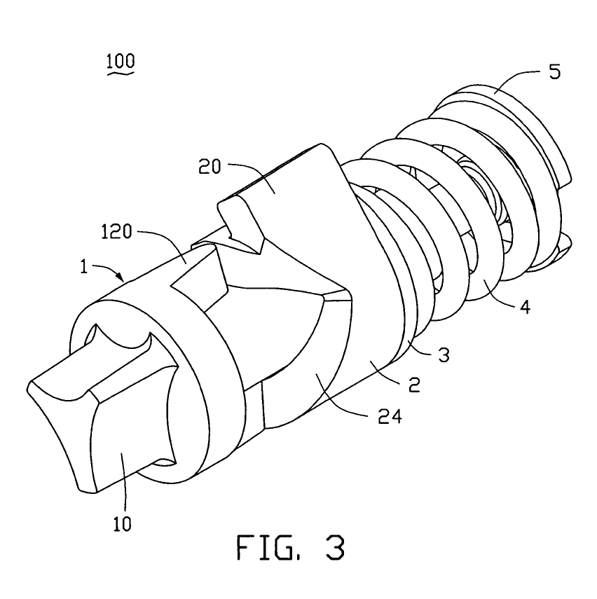

Referring to the FIG. 2 and FIG. 3, in assembly, the shaft portion 13 runs through the cam 2, the washer 3, the spring 4 and the ring 5, in turn. The valleys 240 of the cam 2 match with the tips 122 of the rotating portion 12 of the shaft 1. A space or clearance C exists between the cam 2 and the washer 3 because of the repulsive magnetic force between the flat cam face 28 and the first washer face 30. An end of the spring 4 counteracts the washer 3, and the other end of the spring 4 counteracts the ring 5. The ring 5, setting adjacent to the flange 14, engages with the small shaft 130 to stop the cam 2, the washer 3 and the spring 4 from falling off the shaft 1. The cam 2 is slidable and rotatable on the shaft portion 13 relative to the shaft 1.

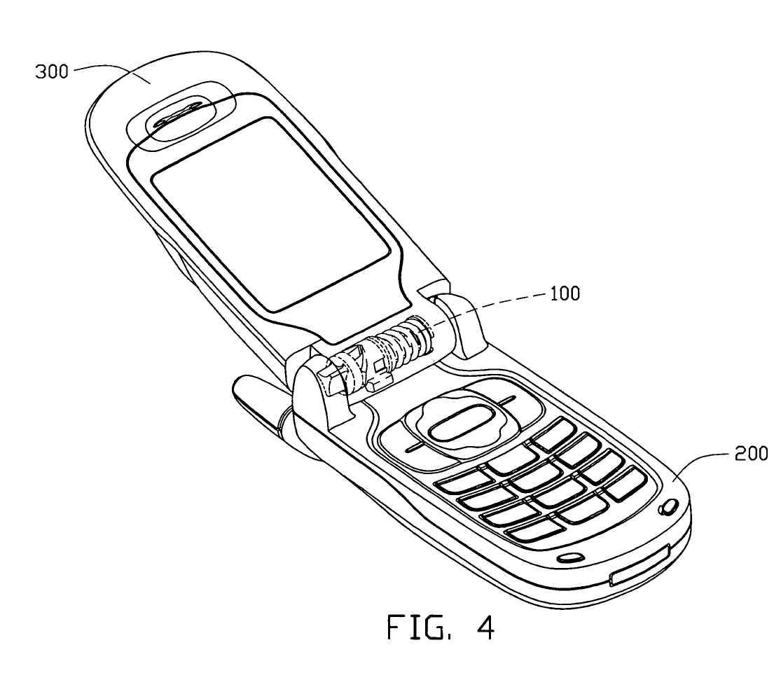

Referring to FIG. 4, the hinge mechanism 100 is used in an exemplary portable electronic device having a main housing 200 and a cover 300. The cam 2 engages with the cover 300 by the rib 20, thereby the cam 2 can rotate together with the cover 300 relative to the main housing 200. The shaft 1 engages with the main housing 200 by the stop portion 10. When the cover is closed, the tips 122 of the rotating portion 12 lie in the valleys 240 of the cam 2, and the spring 4 is in a compressed state.

When rotating the cover 300 manually to open the cover 300, the cam 2 rotates together with the cover 300. The tips 122 of the rotating portion 12 climb up from the valleys 240 to the peaks 242 of the cam 2. The cam 2 rotates and slides relatively to the shaft 1. The spring 4 is further compressed as the cam 2 slides towards the spring 4. When the tips 122 reach the peaks 242 of the cam 2 shown in FIG. 3, the cam 2 and the rotating portion 12 are in an unstable state. Now, the spring 4 is compressed to its extremity. When the tips 122 pass the peaks 242, releasing the cover 300, the bounce or elastic force of the spring 4 causes the cam 2 to rotate until the tips 122 of the rotating portion 12 return into the valleys 240 of the cam 2. Namely, the cover 300 continues to rotate relative to the main housing 200 until the cam 2 stops rotating. Then the cover 300 is opened. The cover 300 can also be opened to a prearranged angle limited by a structural limitation of the main housing 200 and the cover 300. The process of closing the cover 300 is substantially the reverse of the above-described opening process in the same manner.

In the process of opening or closing the cover 300, if the repulsive magnetic force is big enough, although the cam 2 rotates relative to the washer 3, there will not be any friction due to the clearance C existing between the cam 2 and the washer 3. Therefore, the hinge mechanism 100 will reduce friction, decrease wasted energy, and allow a more efficient operation of the hinge mechanism. A formula for computing a friction is F_{f}=μ*N. (F_{f} stands for friction, μ stands for friction coefficient, N stands for pressure). If the repulsive magnetic force between the cam 2 and the washer 3 is not big enough, a clearance C will not exist therebetween, and the flat cam face 28 will touch the first washer face 30. For the washer 3, a pressure (N) is proportional to the sum of the elastic force of the spring 4 and the repulsive magnetic force. For the present hinge system, the pressure of the washer 3 is effectively reduced as the directions of the elastic force (F_{E}) of the spring 4 and the repulsive magnetic force (F_{R}) are opposite (i.e., N=(F_{E}−F_{R})). Even if no clearance C should exist, as the pressure at the cam-washer interface is at least somewhat reduced (relative to the pressure that the spring alone may generate), the friction between the flat cam face 28 and the first washer face 30 is reduced, too.

In alternative embodiment, the rotating portion 12 and the shaft 1 can be manufactured separately and then connected together by another structure. For example, the rotating portion 12 has a hole along an axis thereof, and the shaft 1 has a protrusion at a sidewall thereof. In this instance the protrusion can engage with the hole to connect the rotating portion 12 and the shaft 1 together. Namely, the rotating portion 12 can be a separate cam follower. In addition, the flange 14 can be replaced by a structure of a screw thread and a nut. Furthermore, the flange 14 and the ring 5 can be omitted, and a structure (such as an installation hole) defined in the main housing 200 and the cover 300 will prevent the cam 2, the washer 3 and the spring 4 from falling off from the shaft 1. Moreover, the stop portion 10 can be formed on the rotating portion 12. Furthermore, the spring 4 can be replaced by other elastic member such as rubber bar.

It is believed that the embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

We claim:

1. A hinge mechanism comprising:
a shaft;
a cam follower having a projection connected to the shaft;
a cam having a cam surface and a cam hole defined therein;
an elastic member; and
a washer;
wherein the shaft runs through the cam, the washer and the elastic member, in turn, the cam surface of the cam facing the projection of cam follower, the cam abutting against the cam follower due to the elastic force of the elastic member, the washer and the cam being magnetic, the washer and the cam having respective facing portions, the respective facing portions having the same polarity.

2. The hinge mechanism as claimed in claim 1, wherein one of the shaft and the cam follower forms a stop portion thereon, the cam having a rib formed thereon.

3. The hinge mechanism as claimed in claim 1, wherein the shaft and the cam follower are integrally formed.

4. The hinge mechanism as claimed in claim 1, wherein the shaft and the cam follower are formed separately.

5. The hinge mechanism as claimed in claim 1, wherein a flange is formed at one end of the shaft.

6. The hinge mechanism as claimed in claim 5, wherein the hinge mechanism further comprises a ring, the ring being arranged on the shaft and located adjacent to the flange.

7. The hinge mechanism as claimed in claim 1, wherein a screw thread is formed at one end of the shaft.

8. The hinge mechanism as claimed in claim 7, wherein the hinge mechanism further comprises a nut engaging with the screw thread.

9. An electronic device comprising:
a main housing;
a cover; and
a hinge mechanism for rotatably hinging the main housing and the cover, the hinge mechanism comprising:
a shaft;
a cam follower having a projection connected to the shaft;
a cam having a cam surface and a cam hole defined therein, the cam being magnetic, the cam further having a first cam face, the first cam face having a polarity associated therewith, the cam surface of the cam facing the projection of cam follower;
an elastic member configured for generating an elastic force, the cam abutting against the cam follower due to the elastic force of the elastic member; and
a washer, the washer being magnetic, the washer having a first washer face, the first washer face being directed toward the first cam face, the first washer face having the same polarity associated therewith as the first cam face, the shaft running through the cam, the washer and the elastic member, in turn.

10. The hinge mechanism as claimed in claim 9, wherein the shaft and the cam follower are integrally formed.

11. The hinge mechanism as claimed in claim 9, wherein the shaft and the cam follower are formed separately.

12. The hinge mechanism as claimed in claim 9, wherein a flange is formed at one end of the shaft.

13. The hinge mechanism as claimed in claim 12, wherein the hinge mechanism further comprises a ring, the ring being arranged on the shaft and located adjacent to the flange.

14. The hinge mechanism as claimed in claim 9, wherein a screw thread is formed at one end of the shaft.

15. The hinge mechanism as claimed in claim 14, wherein the hinge mechanism further comprises a nut engaging with the screw thread.
